(19) United States
(12) Patent Application Publication
(10) Pub. No.: US 2008/0040885 A1
(43) Pub. Date: Feb. 21, 2008

(54) Compact functionally layered electronics system

(76) Inventors: Bassel H. Daoud, Parsippany, NJ (US); Monty Richard Dellapi, Oak Ridge, NJ (US); Ronald Andrew Morrison, Morristown, NJ (US); Ivan Pawlenko, Holland, PA (US); Christopher K. Wiese, Long Valley, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/488,280

(22) Filed: Jul. 18, 2006

(51) Int. Cl. E05D 7/00

(52) U.S. Cl. 16/221

(57) ABSTRACT

An electronics system is implemented within a compact enclosure comprising two or more hinged layers. The functionality corresponding to a shelf of a conventional cabinet resides in a corresponding layer. Backplanes are eliminated, each layer having contact surfaces that mate with matching surfaces of adjacent layers when the layers are rotated about their hinges into the closed configuration. Additional interconnection may be made through cabling housed within a special channel or compartment. Each layer may include cooling fans, which are smaller than conventional counterparts (due to shorter convection paths). Expansion may be effectuated by mating additional units of similar conformation in a modular fashion. Optionally, the functionality corresponding to a given layer may be implemented in circuitry integrated onto a single board to reduce cabling and facilitate replacement and repair. Additional functional layers may be stacked along the depth direction as well as the height or width direction.

### FIELD OF THE INVENTION

The present invention relates generally to the field of electronics system enclosures such as, for example, telecommunications base station cabinets, and more particularly to a compact functionally layered implementation for such systems.

### BACKGROUND OF THE INVENTION

Existing designs for electronics system enclosures such as telecommunications base station cabinets typically consist of a single cabinet that contains RF (Radio Frequency) and digital components stacked vertically on top of each other to provide easy front access to them all. The back sides of many of these components are connected to either a cabling harness or a PWB (Printed Wiring Board) backplane. Such a layout necessarily requires a bulky cabinet to accommodate all of these components and their connecting cables. Furthermore, all components are fixed because moveable components would require that their connections between one another be flexible—it is difficult to achieve a flexible connection that does not fatigue and break with time. Furthermore, moving parts are susceptible of getting entangled or “guillotined” by other fixed components. Moreover, when such a prior art cabinet is opened, all components are fully exposed. This is a problem since components that are not being worked on could easily get inadvertently damaged. It would be advantageous to have a new design that eliminates the above-described limitations of prior art enclosures.

### SUMMARY OF THE INVENTION

In accordance with the principles of the present invention, an electronics system, which may, for example, comprise a telecommunications base station cabinet is implemented within a compact enclosure comprising two or more hinged layers. In accordance with an illustrative embodiment of the invention, the functionality corresponding to a shelf of a conventional cabinet advantageously resides in a corresponding layer. Some backplanes may be advantageously eliminated in certain embodiments, each layer of the illustrative embodiment of the invention having contact surfaces that mate with matching surfaces of adjacent layers when the layers are rotated about their hinges into the closed configuration. Additional interconnection may be made, in accordance with certain illustrative embodiments of the invention, through cabling housed within a special channel or compartment.

In accordance with certain illustrative embodiments of the invention, each layer may include cooling fans, which may be advantageously smaller than their conventional counterparts (due to shorter convection paths). Expansion of an electronic system in accordance with the illustrative embodiments of the present invention may be advantageously effectuated by mating additional units of similar conformation in a modular fashion. Optionally, in accordance with certain illustrative embodiments of the invention, the functionality corresponding to a given layer may be implemented in circuitry integrated onto a single board to reduce cabling and to facilitate replacement and repair. Additional functional layers may, in accordance with an illustrative embodiment of the invention, be stacked along the depth direction as well as along the height or the width direction.

In particular, and in accordance with various illustrative embodiments of the present invention, a compact functionally layered electronics system enclosure is thereby provided which advantageously:

(i) utilizes existing RF and digital components;

(ii) exposes only those components that are being worked on while keeping all other components hidden or protected;

(iii) minimizes the size of the cabinet, resulting in a more compact, light weight, and easy to install unit;

(iv) improves the RF performance; provides front access to all components;

(v) eliminates the need for some backplanes; and

(vi) improves the heat dissipation of components.

### BRIEF DESCRIPTION OF THE DRAWINGS

FIG. 1 shows a front view of a prior art telecommunications base station electronics system.

FIG. 2 shows a side view of a prior art telecommunications base station electronics system.

FIG. 3 shows a top view of a compact functionally layered telecommunications base station electronics system in accordance with a first illustrative embodiment of the present invention.

FIG. 4 shows a side view of a compact functionally layered telecommunications base station electronics system in accordance with the first illustrative embodiment of the present invention.

FIG. 5 shows a top view of a compact functionally layered telecommunications base station electronics system in accordance with the first illustrative embodiment of the present invention, wherein individually hinged layers thereof have been opened for servicing.

FIG. 6 shows a top view of a compact functionally layered telecommunications base station electronics system in accordance with a second illustrative embodiment of the present invention.

FIG. 7 shows a top view of a compact functionally layered telecommunications base station electronics system in accordance with the second illustrative embodiment of the present invention, wherein individually hinged layers thereof have been opened for servicing in a first open configuration thereof.

FIG. 8 shows a top view of a compact functionally layered telecommunications base station electronics system in accordance with the second illustrative embodiment of the present invention, wherein individually hinged layers thereof have been opened for servicing in a second open configuration thereof.

FIG. 9 shows a top view of a compact functionally layered telecommunications base station electronics system in accordance with a third illustrative embodiment of the present invention, wherein a first individually hinged layer thereof has been opened for servicing.

FIG. 10 shows a top view of a compact functionally layered telecommunications base station electronics system in accordance with the third illustrative embodiment of the present invention, wherein each of the individually hinged layers thereof have been opened for servicing.

FIG. 11 shows a top view of a compact functionally layered telecommunications base station electronics system in accordance with a fourth illustrative embodiment of the present invention.

FIG. 12 shows a side view of a compact functionally layered telecommunications base station electronics system in accordance with a fifth illustrative embodiment of the present invention.

FIG. 13 shows a front view of a compact functionally layered telecommunications base station electronics system in accordance with the fifth illustrative embodiment of the present invention, wherein the front cover has been removed.

### DETAILED DESCRIPTION OF THE PREFERRED EMBODIMENTS

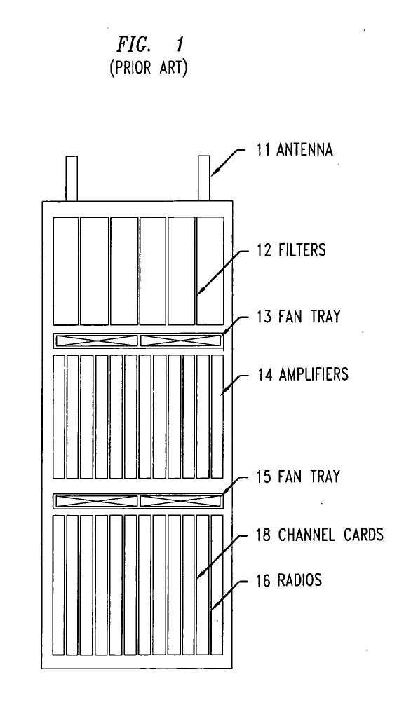

FIG. 1 shows a front view of a prior art telecommunications base station electronics system. The prior art system consists of a number of component sections (i.e., shelves), and comprises antennae 11 (two are shown), filters 12, amplifiers 14, radios 16 and channel cards 18, fan tray 13 (positioned between the shelf comprising filters 12 and the shelf comprising amplifiers 14), and fan tray 15 (positioned between the shelf comprising amplifiers 14 and the shelf comprising radios 16 and channel cards 18). The typical prior art provides the various component sections (ie., shelves) stacked on top of each other in order to provide easy access to all of the components from the “front” of the cabinet. As is typical, the back sides of many of these components may be connected to either a cabling harness or a PWB (Printed Wiring Board) backplane. (Note that the lower shelf comprising both radios 16 and channel cards 18, which advantageously operate together to send and receive signals.)

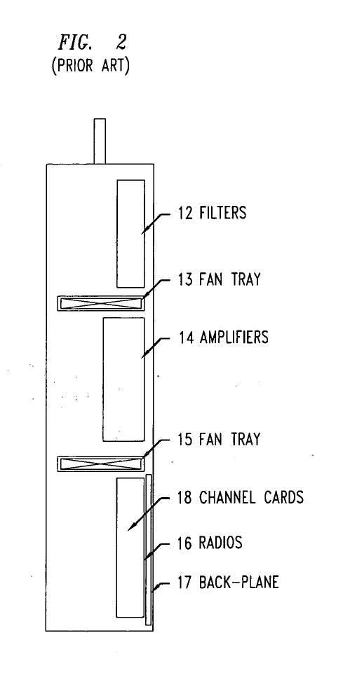

FIG. 2 shows a side view of the prior art telecommunications base station electronics system of FIG. 1. In addition to the components shown in FIG. 1, FIG. 2 shows back-plane 17 to which the back sides of many of the components are connected. (Note that back-plane 17 may alternatively comprise a wiring harness.) Note also that the prior art telecommunications base station electronics system of FIGS. 1 and 2 may be installed in a permanent location with the “back” of the system (i.e., the right side of the side view shown in FIG. 2) affixed to a wall, since all components may be accessed from the “front” of the cabinet (i.e., the left side of the side view shown in FIG. 2).

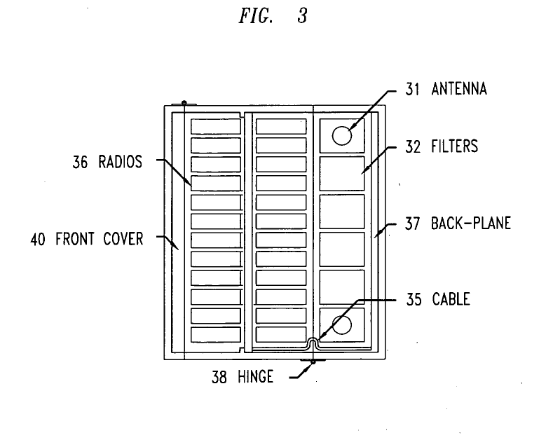

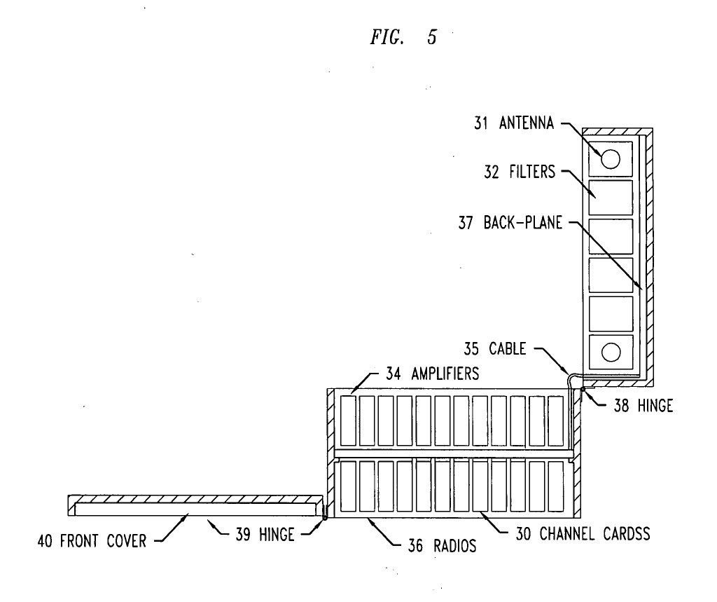

FIG. 3 shows a top view of a compact functionally layered telecommunications base station electronics system in accordance with a first illustrative embodiment of the present invention. The illustrative base station of FIG. 3 advantageously comprises a plurality of hinged layers (i.e., shelves) which may be opened to provide access to otherwise inaccessible layers. (See FIG. 5 and the discussion thereof below.) In particular, the illustrative base station of FIG. 3 comprises (two) antennae 31, filters 32, amplifiers 34, radios 36, channel cards 30, back-plane 37 and front-cover 40, as well as hinge 38, U-shaped cable 35 and hinge 39. U-shaped cable (i.e., wiring harness) 35 advantageously provides necessary electrical connections between back-plane 37 and amplifiers 34, radios 36, and channel cards 30.

The illustrative base station of FIG. 3 specifically comprises 3 individual layers plus front cover 40, each of which may advantageously be individually accessed with use of hinge 38 and/or hinge 39. One such layer comprises antenna 31 and filters 32 (along with back-plane 37); a second such layer comprises amplifiers 34; and a third such layer comprises radios 36 and channel cards 30. (Note again that radios 36 and channel cards 30 advantageously operate together to send and receive signals.) Hinge 38 may be advantageously operated to provide access to filters 31 as well as to amplifiers 34, while hinge 39 may be advantageously operated to provide access to radios 36 and channel cards 30 (by opening front cover 40). Note that the illustrative base station of FIG. 3 may be installed in a permanent physical location with the “back” of the system (i.e., the right side of the top view of the illustrative base station shown in FIG. 3) affixed to a wall.

In accordance with certain illustrative embodiments of the present invention, the layers may comprise electrical contacts surfaces that mate with matching surfaces of adjacent layers and thereby result in an electrical connection therebetween when the layers are rotated about their hinges into the closed configuration (and which thereby electrically disconnect from each other when the layers are rotated about their hinges into an opened configuration). In addition, each layer may be advantageously outfitted with cooling fans (not shown in the figures), which may be smaller than their conventional counterparts due to shorter convection paths.

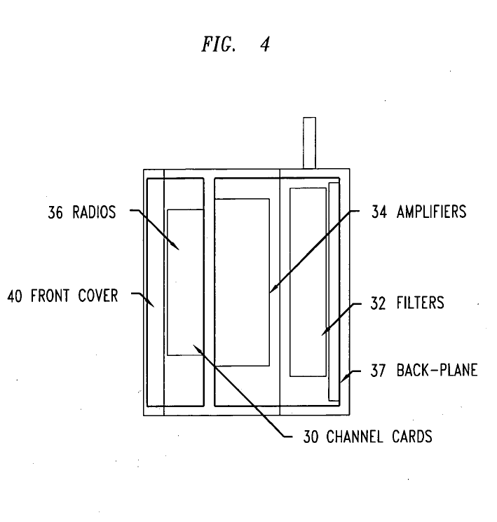

FIG. 4 shows a side view of the illustrative compact functionally layered telecommunications base station electronics system of FIG. 3 in accordance with the first illustrative embodiment of the present invention. Most (but not all) of the components shown in the top view of FIG. 3 are also shown in the side view of FIG. 4.

FIG. 5 shows a top view of the compact functionally layered telecommunications base station electronics system of FIG. 3 in accordance with the first illustrative embodiment of the present invention, wherein individually hinged layers thereof have been opened for servicing. In particular, FIG. 5 shows both hinge 38 and hinge 39 in an “opened” position, thereby permitting access to the components in each of the individual layers of the illustrative base station. Note that FIG. 5 is shown in a similar physical orientation to that shown in FIG. 3, wherein the first layer (i.e., the layer comprising filters 32, antennae 31 and back-plane 37) may be affixed to a wall along its right edge. As such, the pair of layers comprising (a) amplifiers 34 and (b) radios 36 and channel cards 30, are shown “swung” out from the first layer (via the operation of hinge 38), and front cover 40 is shown “swung” out from the layer comprising radios 36 and channel cards 30 (via the operation of hinge 39). Finally, note that U-shaped cable (i.e., wiring harness) 35 advantageously flexes along with the operation of hinge 38.

In accordance with certain illustrative embodiments of the present invention, hinges may advantageously include electrical contacts therein, such that power to one or more layers is turned off when a given hinge is opened (and turned back on when it is closed). In addition, the opening of a given hinge may operate a light switch such that a light is turned on upon the opening of the hinge for servicing purposes. Moreover, hinges in some illustrative embodiments may be easily disconnected (and reconnected) to enable easy upgrades (by, for example, connecting additional layers to the system).

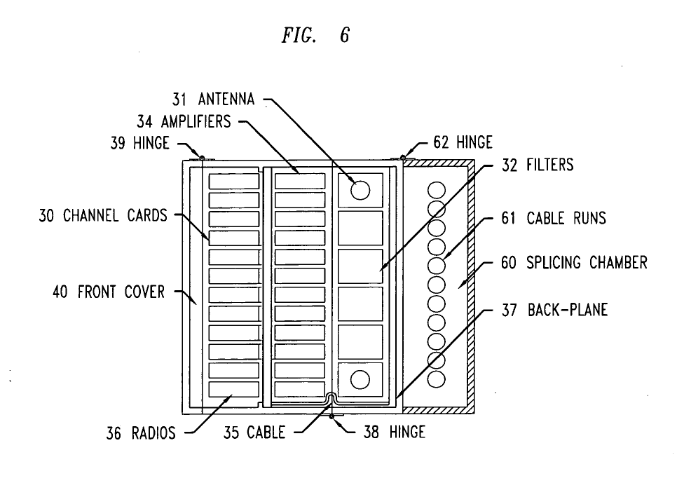

FIG. 6 shows a top view of a compact functionally layered telecommunications base station electronics system in accordance with a second illustrative embodiment of the present invention. The illustrative base station of FIG. 6 comprises an additional layer to those comprised in the illustrative base station of FIGS. 3-5. In particular, the illustrative base station of FIG. 6 comprises splicing chamber 60 which may be affixed to a wall along its right edge (as shown) when the illustrative base station of FIG. 6 is to be installed in a permanent physical location. Splicing chamber 60 advantageously comprises a plurality of cable runs 61 for use in running electrical cables vertically through the (back portion of the) base station. In one illustrative embodiment of the present invention, multiple cabinets in accordance with the principles of the present invention may be stacked vertically, in which case cable runs 61 may be advantageously used for electrical cables interconnecting the vertically stacked units. The illustrative base station of FIG. 6 also includes hinge 62 for providing a hinged connection between splicing chamber 60 and the remaining layers of the base station—in particular, a hinged connection to the layer comprising filters 32, antennae 31 and back-plane 37—to allow access to splicing chamber 61.

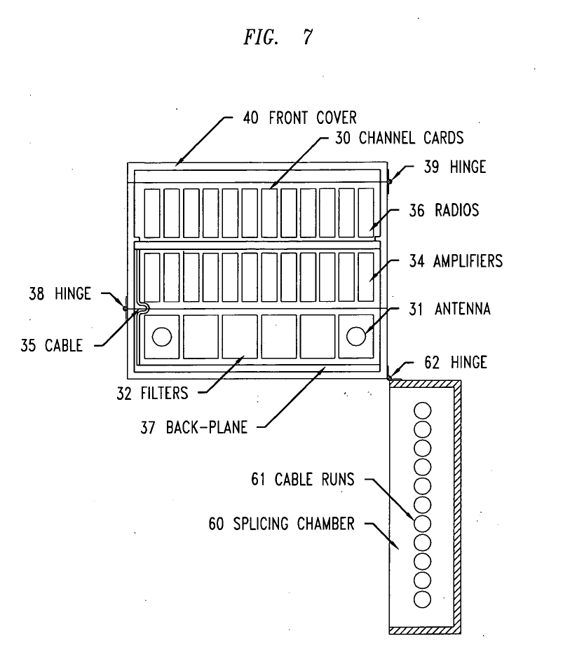

FIG. 7 shows a top view of the compact functionally layered telecommunications base station electronics system of FIG. 6 in accordance with the second illustrative embodiment of the present invention, wherein individually hinged layers thereof have been opened for servicing in a first open configuration thereof. FIG. 7 is shown in a similar physical orientation to that shown in FIG. 6, wherein the layer comprising splicing chamber 60 may be affixed to a wall along its right edge. In particular, as shown in FIG. 7, splicing chamber 60 and the remaining layers of the base station have been “swung open” via the operation of hinge 62.

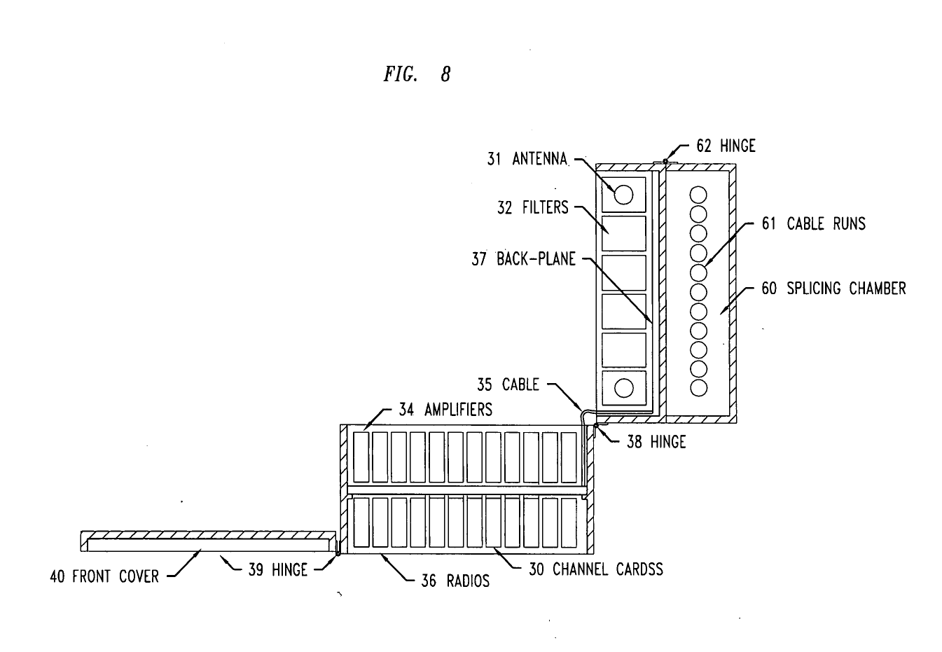

FIG. 8 shows a top view of the compact functionally layered telecommunications base station electronics system of FIG. 6 in accordance with the second illustrative embodiment of the present invention, wherein individually hinged layers thereof have been opened for servicing in a second open configuration thereof. Again, FIG. 8 is shown in a similar physical orientation to that shown in FIG. 6, wherein the layer comprising splicing chamber 60 may be affixed to a wall along its right edge. In particular, as shown in FIG. 8, both hinge 38 and hinge 39 are shown in an “open” position, thereby permitting access to the components in each of the individual layers of the illustrative base station. As such, the pair of layers comprising (a) amplifiers 34 and (b) radios 36 and channel cards 30, are shown “swung” out from the first layer (via the operation of hinge 38), and front cover 40 is shown “swung” out from the layer comprising radios 36 and channel cards 30 (via the operation of hinge 39). Finally, note that U-shaped cable (i.e., wiring harness) 35 advantageously flexes along with the operation of hinge 38.

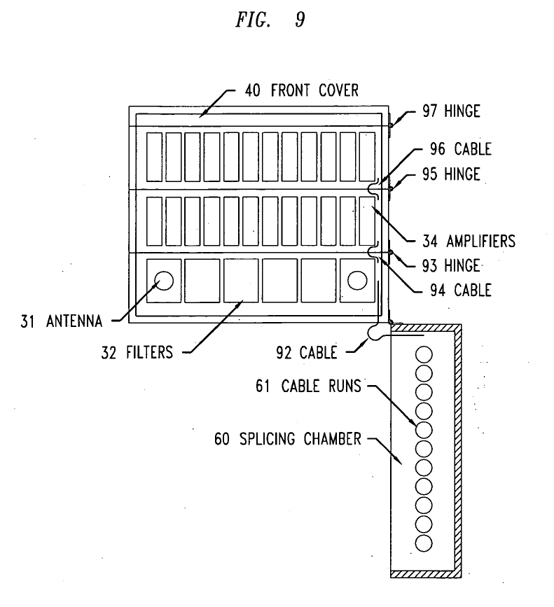

FIG. 9 shows a top view of a compact functionally layered telecommunications base station electronics system in accordance with a third illustrative embodiment of the present invention, wherein a first individually hinged layer thereof has been opened for servicing. The third illustrative embodiment of the invention shown in FIG. 9 is similar to the second illustrative embodiment of the invention as shown in FIGS. 6-8 except that the third illustrative embodiment of FIG. 9 comprises hinges 91, 93, 95 and 97, along with cables (i.e., wiring harnesses) 92, 94 and 96, such that each layer of the cabinet can be individually opened and accessed from both sides thereof. Note that the third illustrative embodiment of the present invention shown in FIG. 9 may be advantageously used with existing components since access to both the front and rear of each layer is provided.

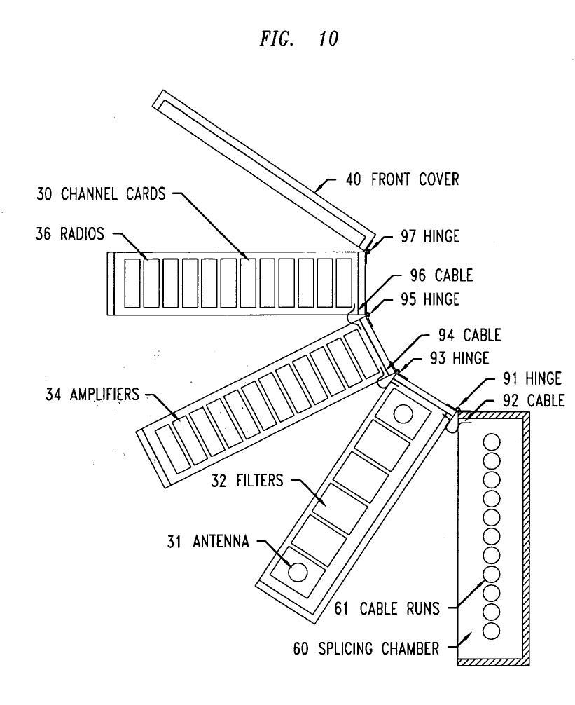

FIG. 10 shows a top view of a compact functionally layered telecommunications base station electronics system in accordance with the third illustrative embodiment of the present invention, wherein each of the individually hinged layers thereof have been opened for servicing. The compact functionally layered telecommunications base station electronics system in accordance with the third embodiment of the invention comprises the same components as are shown in FIG. 9.

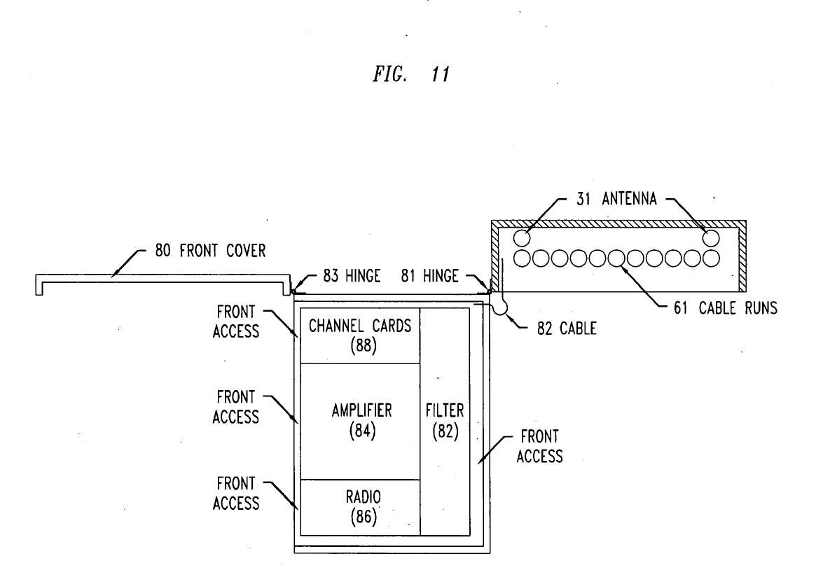

FIG. 11 shows a top view of a compact functionally layered telecommunications base station electronics system in accordance with a fourth illustrative embodiment of the present invention. In accordance with the fourth embodiment of the invention, a single integrated RF (radio frequency) module advantageously comprises filter 82, amplifier 84, radio 86 and channel card 88, and advantageously provides easy access to all portions thereof. In particular, access may be achieved on both the front and rear portion of the integrated module. Interconnection between the subcomponents may be advantageously effectuated within the module, with no need for a back-plane. As also shown in the figure, incoming cables may be advantageously routed through cable runs 61 in a rear interconnection compartment, and these may then be routed to the integrated RF module(s) via U-shaped cable (i.e., wiring harness) 82, which advantageously flexes along with the operation of hinge 81. Finally, front cover 80 may be opened with use of hinge 83.

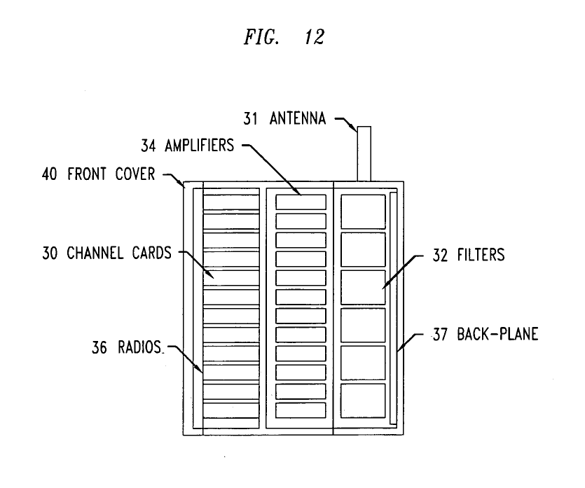

FIG. 12 shows a side view of a compact functionally layered telecommunications base station electronics system in accordance with a fifth illustrative embodiment of the present invention. In accordance with the fifth illustrative embodiment of the invention, wherein the components are mounted in each layer of the base station horizontally rather than vertically. The illustrative base station as shown in the figure comprises antennae 31 and front cover 40, as well as three layers each having respective components mounted horizontally therein. In particular, a first layer (which, may advantageously be installed in a permanent physical location with the “back” of the system—i.e., the right side of the side view of the illustrative base station shown in FIG. 12—affixed to a wall) comprises back-plane 37 and a plurality of filters 32, mounted horizontally; a second layer comprises a plurality of amplifiers 34, mounted horizontally; and a third layer comprises a plurality of radios 36 and channel cards 30, mounted horizontally. Again, note that the illustrative base station of FIG. 12 may be advantageously installed in a permanent physical location with the “back” of the system—i.e., the right side of the side view of the illustrative base station shown in FIG. 12—affixed to a wall.

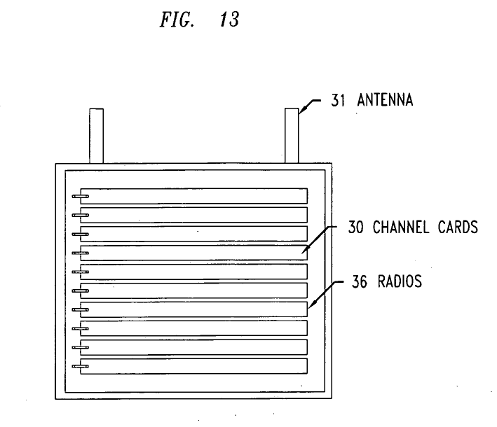

FIG. 13 shows a front view of the compact functionally layered telecommunications base station electronics system of FIG. 12 in accordance with the fifth illustrative embodiment of the present invention, wherein the front cover has been removed (in order to show the components therein. In particular, the figure shows, in addition to antennae 31, a plurality of horizontally mounted radios 36 and channel cards 30, which are comprised in the front layer of the illustrative base station (which corresponds to the third layer shown in FIG. 12).

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. An electronics system enclosure comprising:
a plurality of layers, one or more of said plurality of layers comprising a shelf for mounting a plurality of electronic components therein, each layer having a front side and a back side thereof; and
one or more hinges, each hinge connected to a pair of said layers, each hinge operative to mate the front side of one of said pair of said layers together with the back side of the other one of said pair of said layers when said hinge is rotated into a closed position, and each hinge operative to provide access to at least one of the front side of said one of said pair of said layers and the back side of the other one of said pair of said layers when said hinge is rotated into an opened position.

2. The electronics system enclosure of claim 1 wherein each of said layers connected to a given one of said hinges comprise corresponding electrical contact surfaces which create electrical connectivity when said given hinge is rotated into the closed position and which terminate said electrical connectivity when said given hinge is rotated into the opened position.

3. The electronics system enclosure of claim 1 wherein one of said plurality of layers comprises a splicing chamber comprising one or more cable runs therein.

4. The electronics system enclosure of claim 1 further comprising one or more cooling fans.

5. The electronics system enclosure of claim 1 further comprising a U-shaped cable associated with at least one of said hinges and adapted to flex along with said hinge in a corresponding manner as said hinge is rotated into the opened position and is rotated into the closed position, said U-shaped cable providing electrical connectivity between electronic components mounted in the shelf comprised in one of said layers connected to said at least one of said hinges and electrical components mounted in the shelf comprised in the other one of said layers connected to said at least one of said hinges.

6. The electronics system enclosure of claim 1 further comprising a front cover, said front cover connected to a hinge which is also connected to a front side of one of said layers.

7. The electronics system enclosure of claim 1 wherein at least one of said hinges comprises an electrical contact therein and operates to turn power off to one or more layers of said electronics system enclosure when said hinge is rotated into the opened position and to turn power on to said one or more layers of said electronics system enclosure when said hinge is rotated into the closed position.

8. The electronics system enclosure of claim 1 wherein at least one of said hinges comprises an electrical contact therein and operates to turn a light on when said hinge is rotated into the opened position and to turn said light off when said hinge is rotated into the closed position.

9. The electronics system enclosure of claim 1 wherein at least one of said one or more hinges is adapted to be disconnected and reconnected to one of said layers, thereby providing an ability to add and remove layers from the electronics system enclosure.

10. An electronics system comprising:
a plurality of layers, one or more of said plurality of layers comprising a shelf having mounted therein a plurality of electronic components, each layer having a front side and a back side thereof; and
one or more hinges, each hinge connected to a pair of said layers, each hinge operative to mate the front side of one of said pair of said layers together with the back side of the other one of said pair of said layers when said hinge is rotated into a closed position, and each hinge operative to provide access to at least one of the front side of said one of said pair of said layers and the back side of the other one of said pair of said layers when said hinge is rotated into an opened position.

11. The electronics system of claim 10 wherein said electrical components mounted in said shelf comprised in said one or more of said plurality of layers are mounted vertically therein.

12. The electronics system of claim 10 wherein said electrical components mounted in said shelf comprised in said one or more of said plurality of layers are mounted horizontally therein.

13. The electronics system of claim 10 wherein one of said plurality of layers comprises a splicing chamber comprising one or more cable runs therein.

14. The electronics system of claim 10 further comprising one or more cooling fans.

15. The electronics system of claim 10 further comprising a U-shaped cable associated with at least one of said hinges and adapted to flex along with said hinge in a corresponding manner as said hinge is rotated into the opened position and is rotated into the closed position, said U-shaped cable providing electrical connectivity between electronic components mounted in the shelf comprised in one of said layers connected to said at least one of said hinges and electrical components mounted in the shelf comprised in the other one of said layers connected to said at least one of said hinges.

16. The electronics system of claim 10 further comprising a front cover, said front cover connected to a hinge which is also connected to a front side of one of said layers.

17. A telecommunications base station comprising:
one or more antennae;
a plurality of layers, one or more of said plurality of layers comprising a shelf having mounted therein a plurality of electronic components, each layer having a front side and a back side thereof; and
one or more hinges, each hinge connected to a pair of said layers, each hinge operative to mate the front side of one of said pair of said layers together with the back side of the other one of said pair of said layers when said hinge is rotated into a closed position, and each hinge operative to provide access to at least one of the front side of said one of said pair of said layers and the back side of the other one of said pair of said layers when said hinge is rotated into an opened position.

18. The telecommunications base station of claim 17 wherein said plurality of layers includes a layer comprising a shelf having one or more filters mounted therein, a layer comprising a shelf having one or more amplifiers mounted therein, and a layer comprising a shelf having one or more radios and one or more channel cards mounted therein.

19. The telecommunications base station of claim 17 wherein said plurality of layers includes at least one layer which comprises a shelf having one or more integrated RF modules mounted therein, wherein each of said integrated RF modules comprises a filter, an amplifier, a radio and a channel card.

20. The telecommunications base station of claim 17 further comprising a U-shaped cable associated with at least one of said hinges and adapted to flex along with said hinge in a corresponding manner as said hinge is rotated into the opened position and is rotated into the closed position, said U-shaped cable providing electrical connectivity between electronic components mounted in the shelf comprised in one of said layers connected to said at least one of said hinges and electrical components mounted in the shelf comprised in the other one of said layers connected to said at least one of said hinges.
